(19) United States
(12) Patent Application Publication
(10) Pub. No.: US 2020/0089467 A1
(43) Pub. Date: Mar. 19, 2020

(54) WELDING HELMETS AND METHODS TO PROVIDE AUDIO FEEDBACK IN A WELDING HELMET

(71) Applicant: Illinois Tool Works Inc., Glenview, IL (US)

(72) Inventor: Jake Zwayer, Appleton, WI (US)

(21) Appl. No.: 16/570,415

(22) Filed: Sep. 13, 2019

Related U.S. Application Data
(60) Provisional application No. 62/731,372, filed on Sep. 14, 2018.

(51) Int. Cl. G06F 3/16; H04W 4/80; H04R 1/02; H04R 3/12; H04R 27/00; G09B 19/24; G09B 5/04; B23K 31/12; A42B 3/30

(52) U.S. Cl. CPC G06F 3/165; H04W 4/80; H04R 1/025; H04R 3/12; H04R 27/00; H04R 2227/003; G09B 5/04; B23K 31/125; A42B 3/30; H04R 2420/07; G09B 19/24

(57) ABSTRACT

Welding helmets and methods to provide audio feedback in a welding helmet are disclosed. An example welding helmet includes: an audio device attached to the helmet, the audio device configured to output audio to the user wearing the helmet; communication circuitry configured to: receive first audio information from at least one of a personal audio device, a weld management system, a weld training system, or an audio communication system, wherein the speaker is configured to output first audio based on the first audio information; and receive second audio information from another one of the weld management system, the weld training system, or the audio communication system, the speaker configured to output second audio based on the received second audio information; and audio processing circuitry configured to interrupt playback of the first audio in response to receiving the audio message to play the second audio based on the second audio information.

### RELATED APPLICATIONS

This patent claims priority to U.S. Provisional Patent Application Ser. No. 62/731,372, filed Sep. 14, 2018, entitled “WELDING HELMETS AND METHODS TO PROVIDE AUDIO FEEDBACK IN A WELDING HELMET.” The entirety of U.S. Provisional Patent Application Ser. No. 62/731,372 is incorporated herein by reference.

### TECHNICAL FIELD

This disclosure relates generally to welding helmets and, more particularly, to welding helmets and methods to provide audio feedback in a welding helmet.

### BACKGROUND

Welding is a process that has increasingly become ubiquitous in all industries. While such processes may be automated in certain contexts, a large number of applications continue to exist for manual welding operations, the success of which relies heavily on the proper use of a welding gun or torch by a welding operator, sometimes referred to as the welder. For instance, improper torch angles (work and travel angles), contact tip-to-work distance, travel speed, and aim are parameters that may dictate the quality of a weld. Even experienced welders, however, often have difficulty monitoring and maintaining these important parameters throughout welding processes. In this regard, the welder may benefit from receiving real time process and system feedback during the welding process.

Welding-type components (e.g., welding torches, welding power supplies and welding helmets) are sometimes used to provide process and system feedback to the welder during the welding process. For example, in conventional welding systems power supplies may use a range of electrical components and/or electrical circuitry to provide appropriate feedback to the welder during the welding operation. For example, there may be light displays located on the user interface panel of the power supply which indicates the voltage setting or wire feed speed setting in illuminated numerical formats.

Conventional short circuit gas metal arc welding (GMAW), also referred to as metal inert gas (MIG) welding, is a welding process in which an electric arc forms between an electrode and pieces of metal that are to be welded. The electric arc generates heat that causes the pieces of metal to melt. Upon cooling down of the melted pieces of metal, the pieces of metal join and form a weld. Electrical and/or physical parameters can be measured and the results of these measurements may be provided to the welder as process and system feedback during the welding operation. The welder may use this feedback information to adjust the welding parameters in real time while welding thus causing in an improvement in the welding process.

### SUMMARY

The present disclosure is directed to welding helmets and methods to provide audio feedback in a welding helmet, substantially as illustrated by and/or described in connection with at least one of the figures, and as set forth in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 illustrates an example welding-type system involving a weld operator using an example welding helmet during an example welding-type process, in accordance with aspects of this disclosure.

FIG. 2 illustrates an example welding helmet, including an integrated communication device and an integrated audio device, to provide audio to a wearer of the welding helmet in accordance with aspects of this disclosure.

FIG. 3 is a block diagram of an example welding helmet that may be used to implement the welding helmet of FIGS. 1 and/or 2.

FIG. 4 is a flowchart representative of example machine-readable instructions which may be executed by the example welding helmet of FIGS. 1-3 to provide audio feedback to a weld operator.

FIG. 5 is a flowchart representative of example machine-readable instructions which may be executed by the example welding helmet of FIGS. 1-3 to determine priority of received audio information and/or priority of audio being played.

The figures are not necessarily to scale. Where appropriate, similar or identical reference numbers are used to refer to similar or identical elements.

### DETAILED DESCRIPTION

Examples of the present disclosure may be described herein below with reference to the accompanying drawings. In the following description, well-known functions or constructions are not described in detail because they may obscure the disclosure in unnecessary detail. For this disclosure, the following terms and definitions shall apply.

As used herein, the terms “about” and/or “approximately,” when used to modify or describe a value (or range of values), position, orientation, and/or action, mean reasonably close to that value, range of values, position, orientation, and/or action. Thus, the examples described herein are not limited to only the recited values, ranges of values, positions, orientations, and/or actions but rather should include reasonably workable deviations.

As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

As used herein, a control circuit may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, the term “processor” means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC). The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like.

As used herein, welding-type power refers to power suitable for welding, cladding, brazing, plasma cutting, induction heating, CAC-A and/or hot wire welding/preheating (including laser welding and laser cladding), carbon arc cutting or gouging, and/or resistive preheating.

As used herein, a welding-type power supply refers to any device capable of, when power is applied thereto, supplying suitable power for welding, cladding, brazing, plasma cutting, induction heating, laser (including laser welding, laser hybrid, and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

Disclosed example welding helmets include: an audio device attached to the welding helmet, the audio device configured to output audio to the user wearing the welding helmet; communication circuitry configured to: receive first audio information from at least one of a personal audio device, a weld management system, a weld training system, or an audio communication system, wherein the speaker is configured to output first audio based on the first audio information; and receive second audio information from another one of the weld management system, the weld training system, or the audio communication system, the speaker configured to output second audio based on the received second audio information; and audio processing circuitry configured to interrupt playback of the first audio in response to receiving the audio message to play the second audio based on the second audio information.

In some examples, the second audio information includes an audio message from the audio communication system, the weld management system, or the weld training system. In some such examples, the communication circuitry is configured to receive the first audio information via a Bluetooth wireless communications connection. In some example welding helmets, the communication circuitry is configured to receive the second audio information via the Bluetooth wireless communications connection, a second wireless communications connection, or a wired communications connection.

In some example welding helmets, the audio message includes at least one of: a consumable material status, a weld parameter status, a work shift event, a workflow event, or welding data. In some examples, the audio message comprises a public address system message. In some examples, the audio message comprises at least one of a travel angle of a weld torch, a work angle of the weld torch, a travel speed of the weld torch, or a contact tip to work distance.

Some example welding helmets further include a storage device storing audio data, wherein the audio processing circuitry is configured to identify the audio data based on the received audio information, and the speaker is configured to play the audio based on the identified audio data. In some examples, the audio processing circuitry is configured to determine whether to play the second audio based on at least one of user login or a priority status of the second audio information. In some example welding helmets, the communication circuitry is configured to receive third audio information, the audio processing circuitry configured to determine whether to play the third audio based on at least one of user login or a priority status of the second audio information, and to discard the third audio information without playback based on determining that the third audio is not to be played.

Disclosed example welding helmets include: an audio device attached to the welding helmet, the speaker configured to output audio to the user wearing the welding helmet; communication circuitry configured to: receive first audio information from at least one of a personal audio device, a weld management system, a weld training system, or an audio communication system, wherein the speaker is configured to output first audio based on the first audio information; and receive second audio information from a public announcement system wherein the public announcement system is not included in the welding helmet, the speaker configured to stop outputting the first audio based on the received public announcement system audio information; and audio processing circuitry configured to interrupt playback of the first audio in response to the received public announcement system audio information.

Disclosed example welding systems include: at least one of a weld training system, a weld management system, or an audio communication system, comprising communication circuitry configured to transmit first audio information corresponding to first audio; and a welding helmet. The welding helmet includes: a shell configured to shield at least a face of a user wearing the welding helmet; headgear coupled to the shell and configured to secure the shell to a head of the user; a speaker attached to at least one of the shell or the headgear on an interior of the welding helmet, the speaker configured to output audio to the user wearing the welding helmet; communication circuitry configured to: receive second audio information from a personal audio device, wherein the speaker is configured to output second audio based on the second audio information; and receive first audio information from the at least one of the weld management system, the weld training system, or the audio communication system, the speaker configured to output the first audio based on the received first audio information; and audio processing circuitry configured to interrupt playback of the first audio in response to receiving the audio message to play the second audio based on the second audio information.

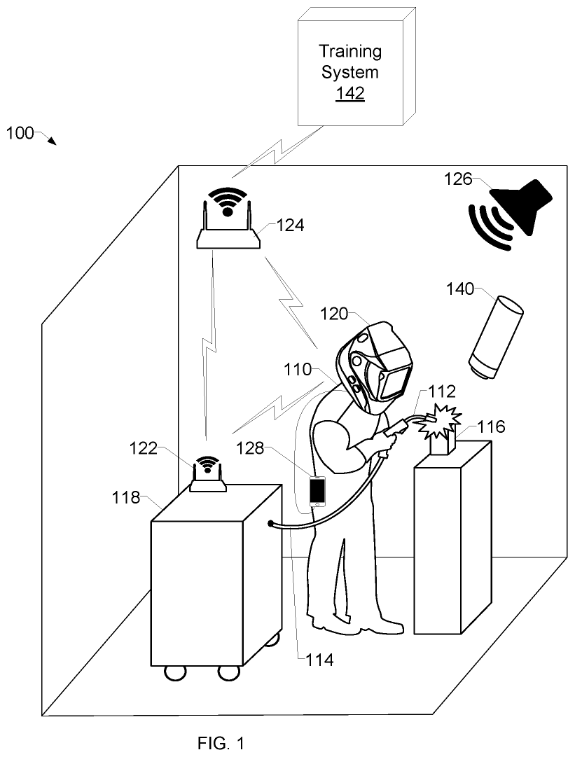

FIG. 1 illustrates an example welding-type system 100 involving a weld operator 110 using an example welding helmet 120 during an example welding-type process. The weld operator 110 wears the welding helmet 120 during a welding operation involving a welding-type power source 118 and a welding torch 112. The welding torch 112 is connected to the welding power source 118 via connecting cables and/or hoses 114. The cables and/or hoses 114 provide electrical power, shielding gas, electrode wire, cooling fluid, and/or any other resources to the welding torch 112. In some examples, the welding system 100 includes a separate wire feeder.

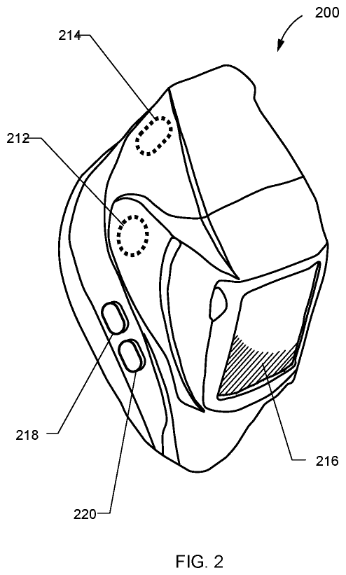

The example welding power source 118 includes a communication device 122 that is used to communicatively couple the welding power source 118 to one or more networks via network communication device 124. The communication device 122 of the welding power source 118 may also be used to communicatively couple the welding power source 118 to the welding helmet 120 via a communication device installed in the welding helmet of the welding helmet 120. An example implementation of the welding helmet 120 is disclosed below with reference to FIG. 2.

The example public address system 126 is an audio communication system in which audio from a first device or location can be broadcast to one or more other locations to be heard by personnel. The public address system 126 may be a digital or analog system. Due to the audible noise associated with manufacturing operations, public address messages transmitted via conventional public address systems are not necessarily heard by weld operators, despite the fact that such public address messages are often of interest to the weld operators.

The personal audio device 128 of FIG. 1 may be a personal audio player, such as a smartphone or other network-connected device, an MP3 player or other playback device having digital media storage, and/or a CD player or other playback device having physical media storage.

The example weld management system 140 monitors welding operations and/or other manufacturing operations associated with the system 100. For example, the system 100 may be located within a weld cell, inside of which the weld management system 140 monitors activity to evaluate weld quality, weld operator efficiency, and/or any other activities associated with the system 100. Example activities may include welding, grinding, fit-up, gouging or other activities associated with re-work, inactivity, fetching parts, and/or any other observable activities. The weld management system 140 may include optical sensors (e.g., cameras for visible wavelengths, infrared wavelengths, ultraviolet wavelengths, etc.), temperature sensors, voltage and/or current sensors, consumable tracking systems, and/or any other sensors or monitors. The weld management system 140 may include one or more computers, servers, and/or other processing resources to receive the observed welding data and process the welding data to evaluate weld quality and/or weld performance, and/or to provide audio feedback to the weld operator 110 via the welding helmet 120.

Conventional weld monitoring systems evaluate welding quality or performance data based on the collected information, and may output the evaluation results. However, conventional weld monitoring systems may require the operator to cease manufacturing activity to view or otherwise interact with the weld monitoring system.

As described in more detail below, the communication devices of the welding helmet 120 may be used to communicatively couple the welding helmet 120 to the example network communication device 124, the example welding power source communication device 122, a public address system 126, a weld management system 140, a personal audio device 128, and/or other sources of audio content to be made available to the weld operator 110. The welding helmet 120 may be communicatively coupled to a wide variety of devices and network connections via the communication devices of the welding helmet 120.

In some examples, the welding system 100 may include a weld training system 142 coupled to any of the power source 118 (e.g., via the communication devices 122 and/or 124), the weld management system 140, the personal audio device 128, and/or the welding helmet 120. The weld training system 142 receives welding data, which may be similar or identical to the weld data received by the weld management system, and/or may include other data representative of weld operator performance. The example weld training system 142 may include electrical sensors, optical sensors or cameras, motion and/or orientation sensors, and/or other sensors configured to measure weld training data. Example weld training data may include torch position (e.g., contact tip to work distance), torch orientation (e.g., work angle, travel angle, etc.), operator position, torch speed, remote control device inputs, and/or any other information indicative of quality and/or performance. The weld training system 142 processes the data to determine audible operator feedback that can be provided to the operator via the welding helmet 120 during and/or after the weld. Example methods and systems that may be used to determine weld training data are described in U.S. Patent Publication No. 2016/0288236, filed Mar. 17, 2016, entitled “Systems and methods for tracking weld training arc parameters.” The entirety of U.S. Patent Publication No. 2016/0288236 is incorporated herein by reference.

For example, the weld training system 142 may transmit audio messages to the welding helmet 120 and/or commands associated with audio messages stored in the welding helmet 120. Example audio messages may include instructions to modify the work angle of the torch, modify the travel angle of the torch, modify the travel speed, adjust the posture of the operator 110, adjust the contact tip to work distance of the torch, and/or any other instructions. Additionally or alternatively, the weld training system 142 may specify a target travel speed, which can be converted to an audible beat for output to the user via the welding helmet 120 to set a pace of travel that may correspond to visible marks on the workpiece 116.

FIG. 2 is a diagram of an example welding helmet 200 equipped with integrated communication devices 214 and integrated audio devices 212, in accordance with aspects of this disclosure. The welding helmet 200 of FIG. 2 is an example of the welding helmet 120 that is depicted in FIG. 1. Referring to FIG. 2, the welding helmet 200 includes a semi-transparent window 216 having a lens, such as an auto-darkening filter or a darkening lens.

The welding helmet 200 includes one or more audio devices 212. Example audio devices may include one or more speakers, a bone conduction device. The audio device(s) 212 may be integrated into the welding helmet 200 or detachable from the welding helmet 200. The audio device(s) 212 play received audio from an external device or system (e.g., the public address system 126, the personal audio device 128, the weld management system 140 of FIG. 1, a weld training system, etc.).

The example welding helmet 200 includes a communication device 214. The communication device 214 may be integrated into the welding helmet 200. The communication device 214 receives audio information from an external device or system, where the audio information is used to output audio via the audio device(s) 212. The communication device 214 may communicate via wired and/or wireless interfaces, such as IEEE 802.X, Bluetooth®, and/or any other wireless interfaces. The communication device 214 is configured to receive audio information from multiple sources, such that audio from one source can take priority (e.g., interrupt) audio from another source.

The weld operator 110 depicted in FIG. 1, may adjust the parameters of the audio devices 212, or the parameters of the communication device 214, using the audio and data control device 218 or the communication control device 220. These control devices 218 and 220 may be used to adjust various other parameters such as the personal audio device 128 that is depicted in FIG. 1.

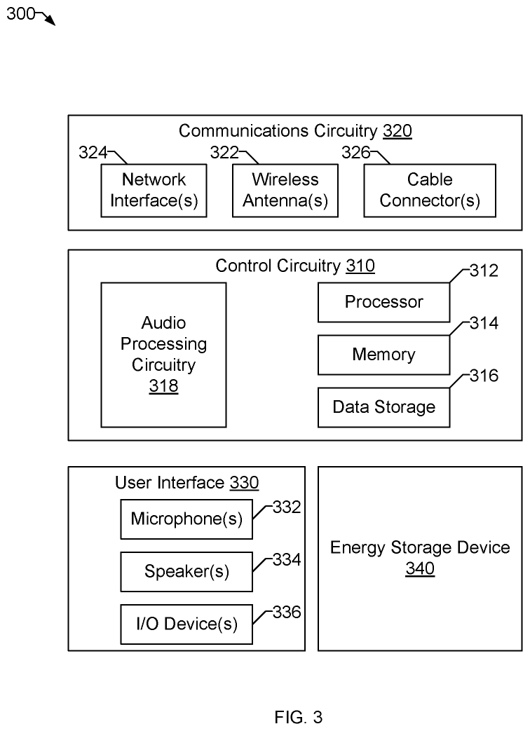

FIG. 3 is a block diagram of example welding helmet 300 that may be used to implement the welding helmets 120, 200 of FIG. 1 or 2. The example welding helmet 300 of FIG. 3 includes control circuitry 310, communications circuitry 320, a user interface 330, and an energy storage device 340.

In the example of FIG. 3, the control circuitry 310 includes processor(s) 312, machine-readable memory 314, a data storage device 316, and audio processing circuitry 318. The control circuitry 310 may be used to control the operation of any aspects of the welding helmet 300. The processor(s) 312 may include one or more microprocessors, such as one or more “general-purpose” microprocessors, one or more special-purpose microprocessors and/or application specific integrated circuits (ASICS), or some combination thereof. For example, the processor(s) may include one or more reduced instruction set (RISC) processors (e.g., Advanced RISC Machine (ARM) processors), one or more digital signal processors (DSPs), and/or other appropriate processors.

The data stored in the data storage device 316 may be received via the operator interface, one or more input/output ports, a network connection, and/or be preloaded prior to assembly of the welding helmet 300. In some examples, the data storage device 316 receives audio data via the communications circuitry 320, for subsequent playback in response to the identification of certain conditions or information by the control circuitry 310. For example, audio messages may be received, updated, and/or otherwise stored in the data storage device 316, for retrieval and playback in response to identification of a condition by the control circuitry 310 and/or receipt of a particular message corresponding to the audio message via the communications circuitry 320.

The communications circuitry 320 includes a wireless antenna 322, one or more network interface(s) 324, and one or more cable connector(s) 326. The example communications circuitry 320 communicates with external devices via the network interface(s) 324, using the wireless antenna 322 and/or the cable connectors 326 based on the type of the interface used to communication. While the example communications circuitry 320 includes network interfaces 324, the communications circuitry 320 may additionally or alternatively communicate via point-to-point communications (e.g., not via a network) using the wireless antenna 322 and/or the cable connectors 326.

The communications circuitry 320 may communicatively couple the control circuitry 310 to the communication device 122, the public address system 126, the personal audio device 128, the weld management system 140, a training system, and/or any other type of communications device. In particular, the example communications circuitry 320 is configured to establish communications with multiple system(s) and/or device(s), and to receive audio information from multiple connected devices for potential playback to the wearer of the welding helmet 300.

The user interface 330 may receive and/or provide signals, data, and/or information to the weld operator 110 via microphone(s) 332, speakers 334, and/or other I/O device(s) 336. The speakers 334 are attached to the welding helmet 300 in a manner in which the wearer can clearly hear audio output from the speakers 334. The example speaker(s) 334 may include drive circuitry, filter circuitry, and/or any other circuitry to output audio via the speakers.

The weld operator 110 may adjust the parameters of the welding helmet 300. For example, the weld operator 110 may use the I/O devices 336 to adjust the volume of the speakers 334, perform remote playback control of the personal audio device 128, and/or set the parameters of the welding helmet 300 according to the personal characteristics and personal needs of the individual weld operator 110. In addition to adjusting the parameters of the welding helmet 300 via the I/O devices 336, the weld operator 110 may use voice commands, received through microphones 332, to adjust the parameters of the control circuitry 310. The microphones 332, the speakers 334, the I/O devices 336, may be part of, or communicatively coupled to, the audio and data control device 218 and communication control device 220 that are depicted in FIG. 2. For example, the weld operator 110 may use voice command signals, via the microphones 332 communicatively coupled to the user interface 330, to instruct the control circuitry 310 to begin or stop providing personal audio signals (e.g. stop playing music that is being played by the personal audio device 128 of FIG. 1).

The energy storage device 340 provides power to the control circuitry 310, the communications circuitry 320, and the user interface 330. The energy storage device 340 may include one or more batteries, and/or any other type of energy storage device.

In operation, the communications circuitry 320 receive first audio information from any of the public address system 126, the personal audio device 128, the weld management system 140 of FIG. 1, and/or a weld training system. The audio processing circuitry 318 processes the first audio information and outputs the first audio via the speaker(s) 334. For example, the communications circuitry 320 may receive personal audio (e.g., music, podcasts, or any other audio selected by the weld operator, such as from the personal audio device 128), and the audio processing circuitry 318 and the speaker(s) 334 play the audio, such as while the weld operator is performing weld operations. During the playback of the first audio, the communications circuitry 320 may further receive second audio information from another one of the weld management system 140, public address system 126, the personal audio device 128, and/or the weld training system 142. The speaker 334 outputs the second audio based on the received second audio information.

The control circuitry 310, upon receiving instructions or commands from the weld operator 110 (e.g., via the communications circuitry 320, via the user interface 330) may modify the audio signal parameters as needed by the operator. For example, the control circuitry 310 may be configured such that a first audio signal received by the weld operator 110 can be adapted to the individual operators requirements and/or preferences. For example, through adjusting of the parameters and the settings of the control circuitry 310, the weld operator may receive relatively more welding process data feedback for a new welder on a particular welding line and/or for any welder operating on a new part, to ensure that no welds are missed and the part is welded correctly. Conversely, when the welder gains more experience and requires less feedback, the control circuitry 310 may be configured to turn off or reduce the feedback delivered via the welding helmet 300. For example, the welding helmet 300 could be configured to reduce the priority of certain training and/or weld management feedback relative to preferred audio (e.g., audio from the personal audio device 128), such that the reduced priority audio does not cause the welding helmet 300 to interrupt other audio.

An example of a higher priority signal is a fire alarm that is broadcasted by the plant public address system 126 of FIG. 1. An example of a lower priority signal is the personal audio signal (e.g. music or radio signals) being generated for entertainment purposes by the personal audio device 128 of FIG. 1. For example, if the weld operator 110 is listening to music, then the weld operator 110 may not be able to hear the fire alarm signal that is being broadcasted by the plant public address system 126 using conventional speakers for a general audience. In contrast, using the example welding helmet 300, the welding helmet 300 may receive two or more signals simultaneously and decide which of the signals is to be output to the operator at a given time. Because the speakers 334 are configured to be heard by the wearer of the helmet (instead of the general audience, the wearer is better able to hear high priority audio while also being able to listen to audio desired by the wearer in the absence of other audio.

The control circuitry 310 determines which signal has the higher priority. The control circuitry 310 may block, pause, and/or mute other signals (e.g. personal audio signal 504 which may be for example music). The control circuitry 310 then provides the weld operator 110, via the user interface 330, the high priority signal (e.g. plant announcement signal 508 which may be for example a fire alarm).

Priority levels may be assigned to classes of messages, in which the message source and/or content determines the priority level of the received signal. Additionally or alternatively, the specific message may be used to set the priority despite a class of message being assigned a different priority.

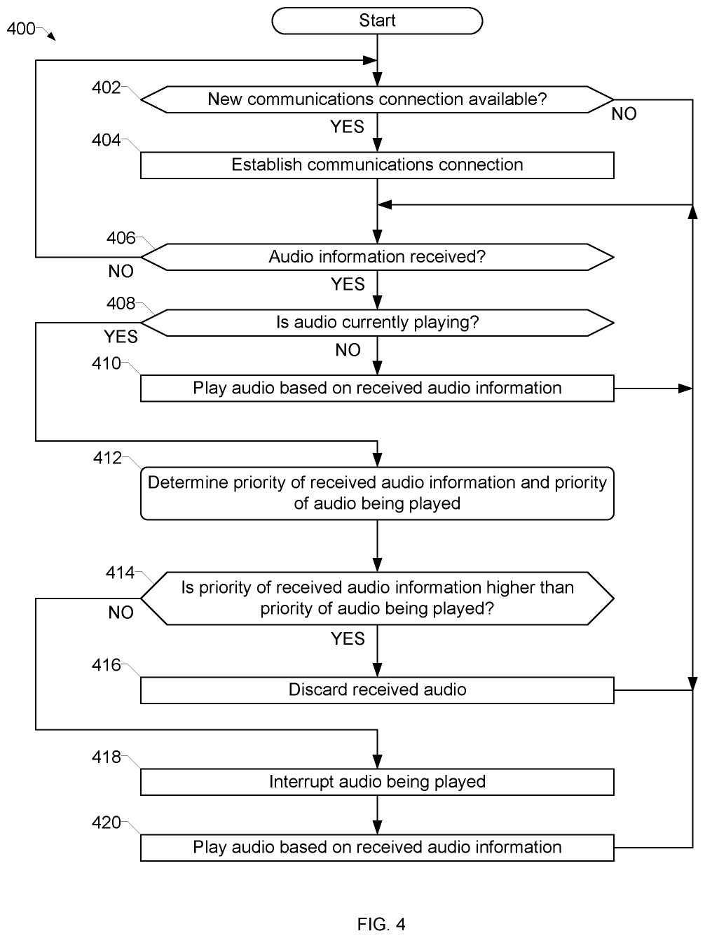

FIG. 4 is a flowchart representative of example machine-readable instructions 400 which may be executed by the example welding helmet 120, 200, 300 of FIGS. 1-3 to provide audio feedback to a weld operator.

At block 402, the communications circuitry 320 determines whether a new connection is available. For example, the communications circuitry 320 may determine that there are new wireless and/or wired connections that can be established to obtain audio information. If a new connection is available (block 402), at block 404 the communication circuitry 320 establishes the connection.

When no new connections are available, at block 406 the communication circuitry 320 determines whether audio information signals have been received. If an audio information signal has not been received (block 406), the communication circuitry 320 returns control to block 402. If an audio information signal has been received (block 406), at block 408 the audio processing circuitry 318 determines whether audio is playing. If no audio is currently playing (block 408), at block 410 the audio processing circuitry 318 plays the audio via the speaker(s) 334 based on the received audio information. For example, the audio processing circuitry 318 may decode compressed audio and output the audio to the speaker(s) 334. In an example, if the welding helmet 300 is not playing any audio, the wearer may choose to begin playing personal audio (e.g., music, podcasts, etc.) by selecting the audio via the personal audio device 128 and/or via the user interface 330.

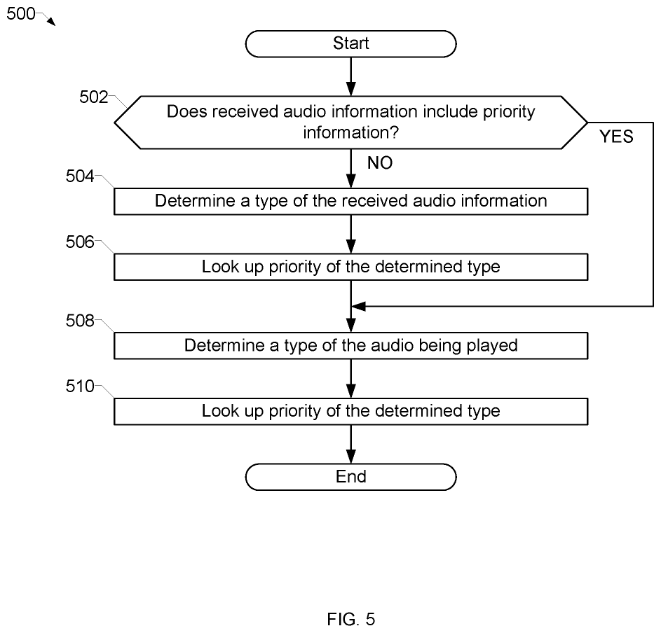

If there is currently audio playing (block 408), at block 412 the control circuitry 310 determines a priority of the received audio information and the priority of the audio being played. Priority information may be received by the communications circuitry 320 in association with received audio information, determined based on a source of the audio, and/or received based on a type of the audio. In some examples, the priority of the audio may be based on the identity and/or credentials of an authenticated wearer of the welding helmet 300. For example, a less experienced weld operator may be required to receive certain messages (e.g., training messages, weld sequencing messages, etc.) that a more experience weld operator may be permitted to block. Example instructions that may be executed to implement block 412 are disclosed below with reference to FIG. 5.

At block 414, the control circuitry 310 determines whether the priority level of the received audio information is higher than the priority level of the audio being played. If the priority level of the received audio information is not higher than the priority level of the audio being played (block 414), at block 416 the control circuitry 310 discards (e.g., does not play) the received audio.

In some examples, if the audio message in the received audio information is not time-sensitive, the control circuitry 310 queues the audio message for playback at a subsequent time (e.g., at the conclusion of the audio being played). For example, the control circuitry 310 may play queued audio messages between audio tracks of a weld operator's personal audio being played.

If the priority of the received audio information is higher than the priority level of the audio being played (block 414), at block 418 the audio processing circuitry 318 interrupts the audio being played. At block 420, the audio processing circuitry 318 plays the audio received based on received audio information. The audio processing circuitry 318 may decode audio data received in the audio information via the communications circuitry 320. For example, the communications circuitry 320 may receive streaming audio data from the external device, which is then decoded and output to the speaker(s) 334 by the audio processing circuitry 318.

Additionally or alternatively, the audio communications circuitry 318 may receive an identification of an audio message to be played, such as a brief file name or other identifier of stored audio data. For example, the audio communications circuitry 318 may receive a “weldOK.mp3” file name or “Weld OK” text string, identifying an audio message stored in the memory 314 or the data storage device 316 containing the audio data to inform the weld operator that a weld (e.g., the most recent weld completed) has been determined by the weld management system 140 to be acceptable. In response, the audio processing circuitry 318 retrieves the identified stored audio data from the memory 314 and/or the data storage device 316, decodes the data, and outputs the audio via the speaker(s) 334.

After playing the received audio (block 410 or block 420), or discarding the audio (block 416), the control circuitry 310 returns control to block 406 to check for additional audio.

FIG. 5 is a flowchart representative of example machine readable instructions 500 which may be executed by the example welding helmet 120, 200, 300 of FIGS. 1-3 to determine priority of received audio information and/or priority of audio being played. The example instructions 500 may be used to implement block 412 of FIG. 4.

At block 502, the communication circuitry 320 of FIG. 3 determines whether the received audio information includes priority information. For example, the audio information received at the communication circuitry 320 may include a priority number or other indicia of the relative priority of the audio information. In an example, a public address message (from the public address system 126 of FIG. 1) may include a priority identifier indicating that the public address message has a high priority. Conversely, personal audio (e.g., music) received from the personal audio device 128 may not have a priority identifier if received via a generic Bluetooth or other wireless or wired connection. If the personal audio does include a priority identifier, the personal audio may be identified with a relatively low priority. In some examples, the established connections are ranked by the control circuitry 310 with relative priorities. Additionally or alternatively, the control circuitry 310 may determine the priorities of received audio information based on the type and/or content of the audio information.

If the received audio information does not include priority information (block 502), at block 504 the control circuitry 310 determines a type of the received audio information. For example, the control circuitry 310 may determine a type based on a source of the received audio information, a size of the received audio information, a network interface from which the audio information was received, and/or any other aspect of the received audio information and/or the source of the received audio information. Example types may be more general, such as a personal audio signal, a public address signal, a welding management signal, or a weld training signal. Example messages may include a consumable material status (e.g., quantity of welding wire remaining on a spool, quantity of welding gas remaining, welding wire replacement is needed, etc.), a weld parameter status (e.g., voltage setpoint, wire feed speed setpoint, current set point, inductance parameter value, selected welding process, etc.), a work shift event (e.g., beginning of work shift, start of a scheduled or unscheduled break period, end of a break period, number of parts completed, etc.), a workflow event (e.g., instruction to be performed by the weld operator, part clamping status, identification of weld to be made by weld operator, pass/fail status of most recent weld, pass/fail status of part, selected weld schedule, etc.), or welding data (e.g., quality metrics, performance metrics, a travel angle of a weld torch, a work angle of the weld torch, a travel speed of the weld torch, or a contact tip to work distance, etc.). At block 506, the control circuitry 310 looks up a priority of the determined type. For example, the data storage device 316 may store a database or lookup table mapping the type information to priority values.

After looking up the priority of the determined type (block 506), or if the received audio information includes priority information (block 502), at block 508 the control circuitry 310 determines a type of the audio being played. For example, the control circuitry 310 may determine the type in a manner similar to determining the type of the received audio information in block 504. Alternatively, the control circuitry 310 may store a priority of the audio being played when the audio is received prior to being played, and the control circuitry 310 may retrieve the type of audio for subsequent comparison with newly received audio. At block 510, the control circuitry 310 looks up the priority of the determined type. For example, the control circuitry 310 may look up the priority in a similar or identical manner as block 506. The example instructions 500 then end, and return control to block 414 of FIG. 4.

The present methods and systems may be realized in hardware, software, and/or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may include a general-purpose computing system with a program or other code that, when being loaded and executed, controls the computing system such that it carries out the methods described herein. Another typical implementation may comprise an application-specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein. As used herein, the term “non-transitory machine-readable medium” is defined to include all types of machine-readable storage media and to exclude propagating signals.

As used herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A welding helmet, comprising:
an audio device attached to the welding helmet, the audio device configured to output audio to the user wearing the welding helmet;
communication circuitry configured to:
receive first audio information from at least one of a personal audio device, a weld management system, a weld training system, or an audio communication system, wherein the speaker is configured to output first audio based on the first audio information; and
receive second audio information from another one of the weld management system, the weld training system, or the audio communication system, the speaker configured to output second audio based on the received second audio information; and
audio processing circuitry configured to interrupt playback of the first audio in response to receiving the audio message to play the second audio based on the second audio information.

2. The welding helmet of claim 1, wherein the second audio information comprises an audio message from the audio communication system, the weld management system, or the weld training system.

3. The welding helmet of claim 2, wherein the communication circuitry is configured to receive the first audio information via a Bluetooth wireless communications connection.

4. The welding helmet of claim 3, wherein the communication circuitry is configured to receive the second audio information via the Bluetooth wireless communications connection, a second wireless communications connection, or a wired communications connection.

5. The welding helmet of claim 2, wherein the audio message comprises at least one of: a consumable material status, a weld parameter status, a work shift event, a workflow event, or welding data.

6. The welding helmet of claim 2, wherein the audio message comprises a public address system message.

7. The welding helmet of claim 2, wherein the audio message comprises at least one of a travel angle of a weld torch, a work angle of the weld torch, a travel speed of the weld torch, or a contact tip to work distance.

8. The welding helmet of claim 1, further comprising a storage device storing audio data, wherein the audio processing circuitry is configured to identify the audio data based on the received audio information, and the speaker is configured to play the audio based on the identified audio data.

9. The welding helmet of claim 1, wherein the audio processing circuitry is configured to determine whether to play the second audio based on at least one of user login or a priority status of the second audio information.

10. The welding helmet of claim 1, wherein the communication circuitry is configured to receive third audio information, the audio processing circuitry configured to determine whether to play the third audio based on at least one of user login or a priority status of the second audio information, and to discard the third audio information without playback based on determining that the third audio is not to be played.

11. A welding helmet, comprising:
an audio device attached to the welding helmet, the speaker configured to output audio to the user wearing the welding helmet;
communication circuitry configured to:
receive first audio information from at least one of a personal audio device, a weld management system, a weld training system, or an audio communication system, wherein the speaker is configured to output first audio based on the first audio information; and
receive second audio information from a public announcement system wherein the public announcement system is not included in the welding helmet, the speaker configured to stop outputting the first audio based on the received public announcement system audio information; and
audio processing circuitry configured to interrupt playback of the first audio in response to the received public announcement system audio information.

12. The welding helmet of claim 11, wherein the second audio information comprises an audio message from the public announcement system.

13. The welding helmet of claim 12, wherein the communication circuitry is configured to receive the first audio information via a Bluetooth wireless communications connection.

14. The welding helmet of claim 13, wherein the communication circuitry is configured to receive the second audio information via the Bluetooth wireless communications connection, a second wireless communications connection, or a wired communications connection.

15. The welding helmet of claim 12, wherein the first audio information comprises at least one of: a consumable material status, a weld parameter status, a work shift event, a workflow event, or welding data.

16. The welding helmet of claim 12, wherein the audio information comprises at least one of a travel angle of a weld torch, a work angle of the weld torch, a travel speed of the weld torch, or a contact tip to work distance.

17. The welding helmet of claim 11, further comprising a storage device storing audio data, wherein the audio processing circuitry is configured to identify the audio data based on the received audio information, and the speaker is configured to play the audio based on the identified audio data.

18. The welding helmet of claim 11, wherein the audio processing circuitry is configured to determine whether to play the second audio based on at least one of user login or a priority status of the second audio information.

19. The welding helmet of claim 11, wherein the communication circuitry is configured to receive third audio information, the audio processing circuitry configured to determine whether to play the third audio based on at least one of user login or a priority status of the first audio information, and to discard the third audio information without playback based on determining that the third audio is not to be played.

20. A welding system, comprising:
at least one of a weld training system, a weld management system, or an audio communication system, comprising communication circuitry configured to transmit first audio information corresponding to first audio; and
a welding helmet, comprising:
a shell configured to shield at least a face of a user wearing the welding helmet;
headgear coupled to the shell and configured to secure the shell to a head of the user;
a speaker attached to at least one of the shell or the headgear on an interior of the welding helmet, the speaker configured to output audio to the user wearing the welding helmet;
communication circuitry configured to:
receive second audio information from a personal audio device, wherein the speaker is configured to output second audio based on the second audio information; and
receive first audio information from the at least one of the weld management system, the weld training system, or the audio communication system, the speaker configured to output the first audio based on the received first audio information; and
audio processing circuitry configured to interrupt playback of the first audio in response to receiving the audio message to play the second audio based on the second audio information.
